(19) United States
(12) Patent Application Publication
(10) Pub. No.: US 2013/0170482 A1
(43) Pub. Date: Jul. 4, 2013

(54) WI-FI DIRECT CONNECTION METHOD

(71) Applicant: Samsung Electronics Co. Ltd., Suwon-si (KR)

(72) Inventor: Bu-Seop JUNG, Suwon-si (KR)

(73) Assignee: SAMSUNG ELECTRONICS CO. LTD., Suwon-si (KR)

(21) Appl. No.: 13/733,327

(22) Filed: Jan. 3, 2013

(30) Foreign Application Priority Data
Jan. 3, 2012 (KR) 10-2012-0000576

(51) Int. Cl. H04W 48/16; H04W 4/00

(52) U.S. Cl. CPC H04W 48/16; H04W 4/005
USPC 370/338

(57) ABSTRACT

A Wireless-Fidelity (Wi-Fi) Direct connection method is provided. The method includes, when a Wi-Fi-Direct connection is requested, performing a device discovery to display a device discovery result and generating a target peer list from Peer-to-Peer (P2P) devices in the displayed device discovery result, performing a provision discovery of a Personal Identification Number (PIN) connection type with the P2P devices within the target peer list, after inputting a PIN, transmitting a PIN check query request message to the P2P devices within the target peer list, and receiving a PIN check query response message from each of the P2P devices within the target peer list, and identifying a status code of each received PIN check query request message establishing the Wi-Fi Direct connection when the status code corresponds to a success.

### PRIORITY

This application claims the benefit under 35 U.S.C. §119(a) of a Korean patent application filed on Jan. 3, 2012 in the Korean Intellectual Property Office and assigned Serial No. 10-2012-000576, the entire disclosure of which is hereby incorporated by reference.

### BACKGROUND OF THE INVENTION

1. Field of the Invention

The present invention relates generally to a field of using Wireless-Fidelity (Wi-Fi) Direct. More particularly, the present invention relates to a field of guaranteeing connection to a Peer-to-Peer (P2P) device which a user desires to connect to among a list of Wi-Fi P2P devices displayed when a Wi-Fi Direct connection is desired.

2. Description of the Related Art

A portable terminal such as a smart phone providing various functions has been widely used. Among the various functions provided by the portable terminal is a Wireless-Fidelity (Wi-Fi) Direct function proposed by the Wi-Fi Alliance.

Wi-Fi Direct corresponds to a new communication method proposed by the Wi-Fi Alliance and allows devices that do not have a hotspot, a router, or an Access Point (AP), but support Wi-Fi Direct (or one side supports Wi-Fi Direct), can share data through communication. Wi-Fi Direct has some similarities to Bluetooth® in that they perform communication between devices, but Wi-Fi Direct has improved transmission range and a data transmission rate. For example, Bluetooth® 4.0 supports a transmission range up to a maximum of 100 meters and a maximum transmission rate of 24 Mbps, but Wi-Fi Direct supports a transmission range up to a maximum of 200 meters and a maximum transmission rate of 300 Mbps.

When a user makes a request for a Wi-Fi Direct connection, a Wi-Fi Peer-to-Peer (P2P) device of the user displays a list of P2P devices discovered through a device discovery process and then performs Wi-Fi Direct connection with a P2P device selected by the user from the displayed list.

However, when names of the P2P devices included in the list of the P2P devices are similar, the user may not be sure which P2P device is the device that the user desires to connect to. For example, it is common that Wi-Fi P2P devices have a model name designated by a manufacturer as a default device name. When the user does not change the default device name designated as the model name, the P2P devices in the list of P2P devices may have similar device names.

Accordingly, although the desired P2P device for the Wi-Fi Direct connection is next to the user, the user may not be sure which is the P2P device in the list of P2P devices that is the desired P2P device.

A Wi-Fi Direct connection method includes a Personal Identification Number (PIN) type connection by Wi-Fi Simple Configuration (WSC), in which a P2P device attempting a Wi-Fi Direct connection inputs a PIN value of a P2P device corresponding to a connection target so that the Wi-Fi Direct connection is achieved.

When the Wi-Fi Direct connection is attempted through the PIN type connection, the Wi-Fi Direct connection may be requested with an input of an incorrect PIN. A user is informed in four to six seconds after the connection request that the incorrect PIN is input. Accordingly, when the user using Wi-Fi Direct inputs a wrong PIN, the user may identify that the wrong PIN is input after a time passes after the connection attempt, and accordingly the user experiences inconvenience in that the Wi-Fi Direct connection is delayed.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a method of more clearly distinguishing a Wireless-Fidelity (Wi-Fi) Peer-to-Peer (P2P) device corresponding to a connection target when a Wi-Fi Direct connection is attempted and preventing Wi-Fi Direct connection from being delayed due to an input of an incorrect Personal Identification Number (PM).

In accordance with an aspect of the present invention, a Wi-Fi Direct connection method is provided. The method includes, when a Wi-Fi-Direct connection is requested, performing a device discovery to display a device discovery result and generating a target peer list from Peer-to-Peer (P2P) devices in the displayed device discovery result, performing a provision discovery of a PIN connection type with the P2P devices within the target peer list, after inputting a PIN, transmitting a PIN check query request message to the P2P devices within the target peer list, and receiving a PIN check query response message from each of the P2P devices within the target peer list, and identifying a status code of each received PIN check query request message establishing the Wi-Fi Direct connection when the status code corresponds to a success.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a flowchart schematically illustrating a process in which Wi-Fi Direct certified devices generate a Wireless-Fidelity (Wi-Fi) Peer-to-Peer (P2P) group;

FIG. 2A is a first example diagram of a Personal Identification Number (PIN) check query request message and a PIN check query response message used in a Wi-Fi Direct connection method according to an exemplary embodiment of the present invention;

FIG. 2B is a second example diagram of the PIN check query request message and the PIN check query response message used in Wi-Fi Direct connection method according to an exemplary embodiment of the present invention;

FIG. 2C is a third example diagram of the PIN check query request message and the PIN check query response message used in Wi-Fi Direct connection method according to an exemplary embodiment of the present invention;

FIG. 2D is a fourth example diagram of the PIN check query request message and the PIN check query response message used in Wi-Fi Direct connection method according to an exemplary embodiment of the present invention;

FIG. 3 is a flowchart illustrating a Wi-Fi Direct connection process according to an exemplary embodiment of the present invention;

FIG. 4A is a first illustrative diagram of Wi-Fi Direct connection process according to an exemplary embodiment of the present invention; and

FIG. 4B is a second illustrative diagram of Wi-Fi Direct connection process according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In an exemplary embodiment of the present invention, a Wireless-Fidelity (Wi-Fi) Peer-to-Peer (P2P) device includes a communication module having a standard equal to or higher than Institute of Electrical and Electronics Engineers (IEEE) 802.11g (for example, 802.11g or 802.11n) and corresponds to a Wi-Fi Direct certified device. Further, the Wi-Fi P2P device described in the exemplary embodiment of the present invention may be a portable terminal such as a smart phone, a notebook computer, a tablet and the like or an electronic device such as a TeleVision (TV), a printer, a camera and the like.

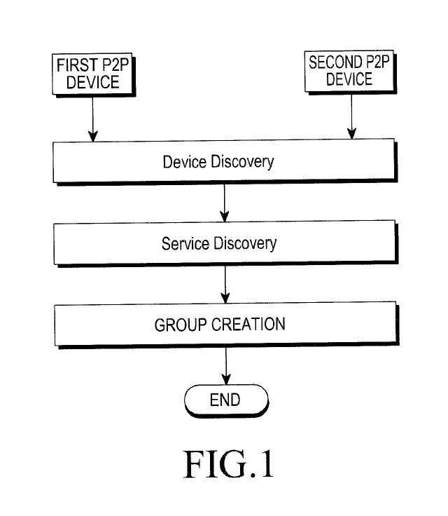

FIG. 1 is a flowchart illustrating a process in which Wi-Fi Direct certified devices establish a Wi-Fi P2P group through a Wi-Fi Direct connection. A Wi-Fi Direct connection (or also referred to as Wi-Fi P2P group establishment) process is described with reference to FIG. 1 below.

Wi-Fi Direct connection is performed largely through three processes including a device discovery, a service discovery, and group establishment (or generation), which will be described below.

### Device Discovery

The device discovery process is required when Wi-Fi P2P devices (for example, a first and a second P2P device) recognize each other to configure a connection to establish the Wi-Fi P2P group.

The Wi-Fi P2P device (for example, the first P2P device) enters a menu to use the Wi-Fi Direct function or, alternatively, enters a device discovery mode in response to an application execution request. The first P2P device searches for neighboring Wi-Fi P2P devices by repeatedly performing channel scan of IEEE 802.11 channels by listening to the channels and searching the channels for a predetermined time period. A basic operation of the device discovery process performed during the Wi-Fi P2P group establishment is implemented by exchanging a probe request message and a probe response message of an IEEE 802.11 Media Access Control (MAC) protocol. The probe request message contains information on P2P Information Element (IE), Wi-Fi Simple Configuration (WSC) IE, Supp Reg IC and like, and the probe response message contains P2P Information Element (IE), Wi-Fi Simple Configuration (WSC) IE, Robust Secure Network (RSN) IE, and Supp Reg IE.

Through the device discovery process, the Wi-Fi Direct function obtains a list of P2P devices that can be used to establish the Wi-Fi P2P group.

For example, a user of the first P2P device can generate a list of neighboring P2P devices (for example, second P2P device) through an activation of the Wi-Fi Direct function, and the list may include a device name contained in the probe response message received from each of the neighboring P2P devices.

### Service Discovery

The service discovery is performed during the aforementioned device discovery process to provide a function of exchanging information on services that each P2P device can support. That is, each P2P device may identify a supportable service protocol, a service and the like through exchange of a request message and a response message.

For example, when the first P2P device is a camera and the second P2P device is a printer, if the user of the first P2P device desires to output a picture, the first P2P device is required to identify whether the second P2P device supports a picture output function. Thus, the first P2P device requests if the second P2P device has the picture output function through a service discovery request.

In another example, when a file sharing function is requested during the Wi-Fi P2P group establishment, the file sharing function between the first and second P2P devices cannot be performed if the first P2P device uses a file sharing method based on a universal Plug and Play (UPnP), but the second P2P device uses a file sharing method based on a Web Service (WS).

### Group Generation

When the P2P group is generated, Wi-Fi Direct requires determining a device to take the role of a group owner that will act as a center of the P2P group.

In order to generate the Wi-Fi P2P group in Wi-Fi Direct, the first and second P2P devices perform a provision discovery.

The P2P devices in Wi-Fi Direct operate based on Wi-Fi Simple Configuration (WSC), such as, for example, based on Wi-Fi Protected Setup (WPS). The support for WSC by the connected device is optional in the related-art Wi-Fi standard, but is mandatory in Wi-Fi Direct.

WSC enables more convenient wireless connection and includes a Push Button Configuration (PBC) connection in which a button is pressed, and a Personal Identification Number (PIN) connection type in which a PIN is input. Both the PBC type and the PIN type should complete a setting within 120 seconds, which can cause user inconvenience. For example, in the PBC connection type, a WSC registration protocol is started when the first P2P device makes a request for wireless connection through the PBC type and then the second P2P device inputs a WPS button within 120 seconds. A Service Set IDentify (SSID) and credential (e.g., a sum of encryption information including information on an authentication type, an encryption type, a network key, an SSID and the like) are exchanged to establish the connection.

Wi-Fi Direct may include a provision discovery type to reduce inconvenience of connecting P2P devices. When the first Wi-Fi P2P device searches for another Wi-Fi P2P device and then attempts connection through the related-art WSC type (e.g., PBC type or PIN type), the attempt at the connection is informed to the user of another Wi-Fi P2P device through transmission of a WSC method message.

When the users of the first P2P device and the second P2P device accept Wi-Fi P2P connection through the PBC type or the PIN type to complete the provision discovery, a Group Owner (GO) negotiation process is performed between the Wi-Fi P2P devices.

The group owner negotiation process is performed by an exchange of a GO negotiation request, a GO negotiation response, and a GO negotiation confirm frame, and the GO negotiation request and the GO negotiation response contain P2P IE information and WSC IE information.

A field of the P2P IE includes information such as P2P capability, P2P device info, group owner intent, configuration timeout, a listen channel, extended listen timing, an intended P2P interface address, a channel list, operating channel attributes and the like. A field of the WSC IE includes information such as a device password IDentifier (ID), a manufacturer, a model name, a model number, a serial number, a device name and the like.

The first P2P device and the second P2P device compare group owner intent values included in the P2P IE. The device having a larger intent value is determined to be the GO and the device having a smaller intent value is determined as a Group Client (GC).

When the first P2P device and the second P2P device are determined as the GO device and the GC device, respectively, the group owner negotiation process is completed. When the GO device operates as a WSC registrar and the GC device operates as a WSC enrollee so that when the exchanging of the credentials is completed, the group establishment process for establishing the Wi-Fi P2P group is completed.

An attribute, which includes a temporary group and a persistent group, of the P2P group is also determined in the group owner negotiation process. The temporary group corresponds to a case where the established P2P group is used once and the persistent group corresponds to a case where the established P2P group is used persistently.

When the generated P2P group is persistently set, P2P devices of the corresponding P2P group store information on the credentials and a role (e.g., group owner or group client) of each P2P device in the P2P group to enable rapid establishment of the P2P group by omitting processes (e.g., the provision discovery, the group owner negotiation and the provisioning when the P2P group establishment is requested) in the future. For example, when a device included in a previous P2P group as a persistent group is discovered during a device discovery process, the group owner device generates the P2P group through an exchange of information (for example, invitation request/response) including information on the attribute of the P2P group, and the group client can rapidly access the P2P group by using the stored information.

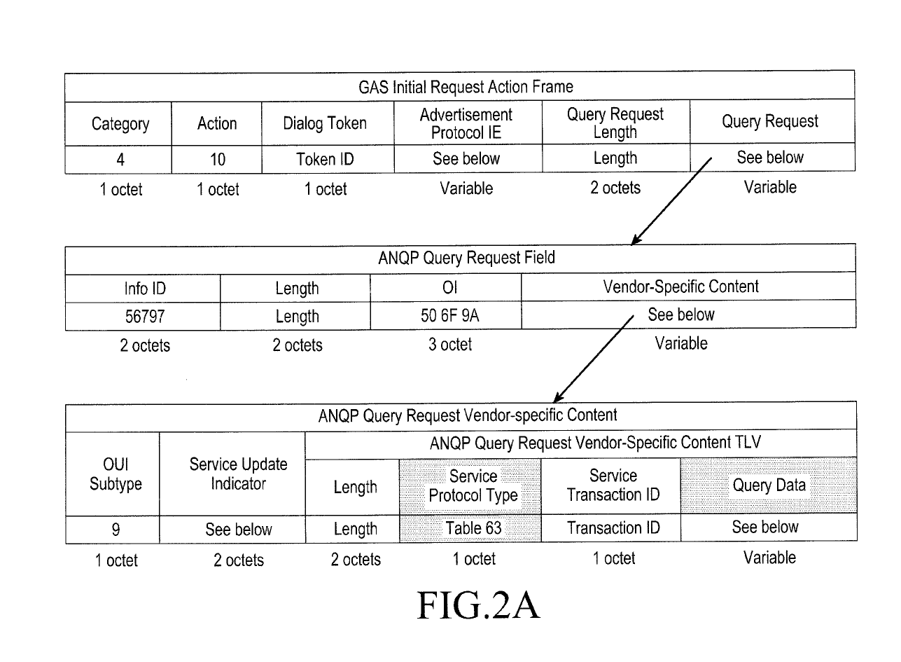

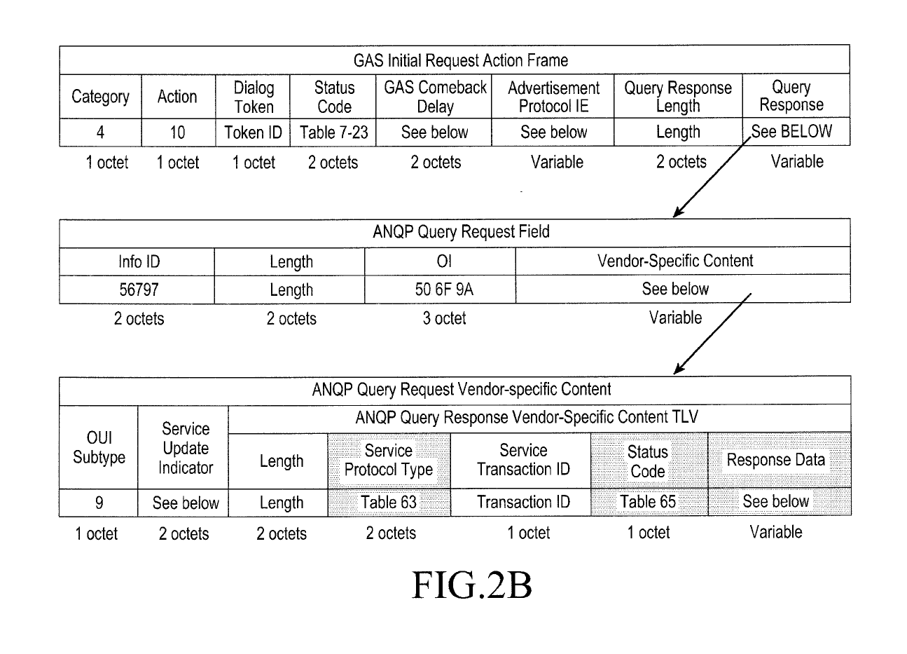

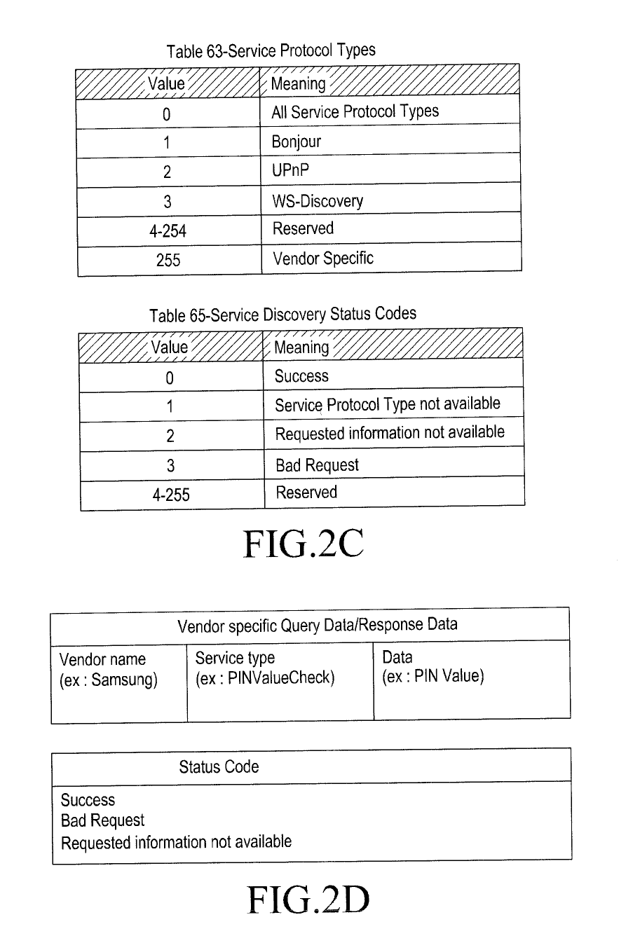

FIGS. 2A to 2D are a first example diagram, a second example diagram, a third example diagram, and a fourth example diagram of a PIN check query request message and a PIN check query response message used in a Wi-Fi Direct connection method according to an exemplary embodiment of the present invention, respectively.

The PIN check query request message and the PIN check query response message used in the exemplary embodiment of the present invention are generated using a Generic Advertisement Service (GAS) protocol frame defined in IEEE 802.11u and then transmitted, as described below with reference to FIGS. 2A to 2D.

The PIN check query request message and the PIN check query response message are exchanged in the service discovery process described above and the specification of Wi-Fi Direct indicates that the GAS protocol frame may be applied and used according to a need of the manufacturer.

Accordingly, when the PIN check query request message and the PIN check query response message are exchanged using fields (e.g., ANQP query request field and ANQP query response field) of a vendor-specific content of the GAS protocol frame (e.g., GAS initial request action frame and GAS initial response action frame) defined in related-art IEEE 802.11u are modified and used as illustrated in FIGS. 2A and 2B.

Referring to FIGS. 2A and 2B, the PIN check query request message modifies a service protocol type and query data in the vendor-specific content. The PIN check query response message modifies the service protocol type, a status code, and response data in the vendor-specific content.

A type of the service protocol used in the P2P group established through Wi-Fi Direct connection is designated in the service protocol type illustrated in FIGS. 2A and 2B and service information corresponding to the designated type of the service protocol is included in the query data and the response data.

With reference to FIG. 2C, the service protocol type divides types of the service protocol into all protocol types, PnP, Bonjour, and WS-discovery using different values of an 8-bit field. In the example of FIG. 2C, the remaining values, which are 4 to 254 and 255, may be defined according to future expansions and discretion of the manufacturer.

Further, the status code illustrated in FIG. 2C divides different response results of the service discovery request to different values (e.g., 0 indicating success, etc.), and the remaining values, which are 4 to 255, may be defined in future expansions. The status code is allocated values of 0, 1, 2, and 3 corresponding to success, service protocol type not available, requested information not available, and bad request.

Referring to FIG. 2D, the query data of the PIN check query request message, the response data of the PIN check query request message, and the PIN check query response message include a vender name, a service type, and data such as a PIN value. For example, the status code of the PIN check query response message includes response information having values such as 0, 2, and 3, which correspond to success, requested information not available, and bad request, as noted above.

The vender name, the service type, the data, and the status code illustrated in FIG. 2D will be described below.

### Vendor Name

In the related art, the P2P group generating method for the Wi-Fi Direct standard and the P2P group generating method is performed through division of the vendor names.

The vender name may be designated as a manufacturer name of the P2P device (e.g., Samsung®) that may be specific to P2P devices manufactured by that particular vendor.

In other examples, an operating system name may be designated as the vender name in P2P devices using a particular operating system such as Bada® or Android®, for example.

### Service Type

A service type field distinguishes a particular vendor specific service to be requested or responded to. It may be specified that a dedicated service provided by the manufacturer is associated with identification of a PIN of the corresponding P2P device for Wi-Fi Direct connection by declaring a field such as PINValueCheck in a field of the service type.

### Data

An input PIN value or a PIN value which is being displayed is designated in the data field.

### Status Code

The status code field, which is received by the P2P device attempting a Wi-Fi Direct connection to a desired P2P device, is used to designate a response result of the PIN check query request message in the PIN check query response message. For example, the status code may declare success, bad request, and requested information not available.

The success is designated when data (for example, input PIN value) of the query data of the PIN check query request message is identical to the PIN value which is being displayed. For example, the status code has a value of 0 as illustrated in FIG. 2C indicates success.

The bad request is designated when a PIN value is not being displayed (when the provision discovery is not performed) on the device. That is, the device transmitting the status code is not the desired P2P device. For example, the status code has a value of 3 as illustrated in FIG. 2C to indicate bad request. In this case, the data does not have a separate value in the response data of the PIN check query response message.

The requested information not available is designated when the data of the query data of the PIN check query request message is not the same as the PIN value which is being displayed. For example, the status code has a value of 2 as illustrated in FIG. 2C to indicate requested information not available.

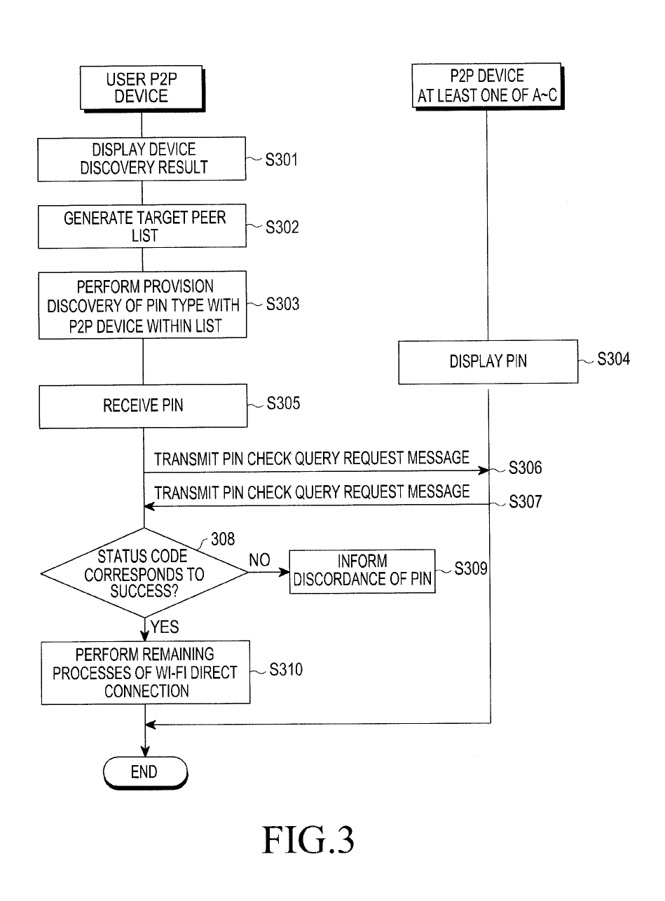

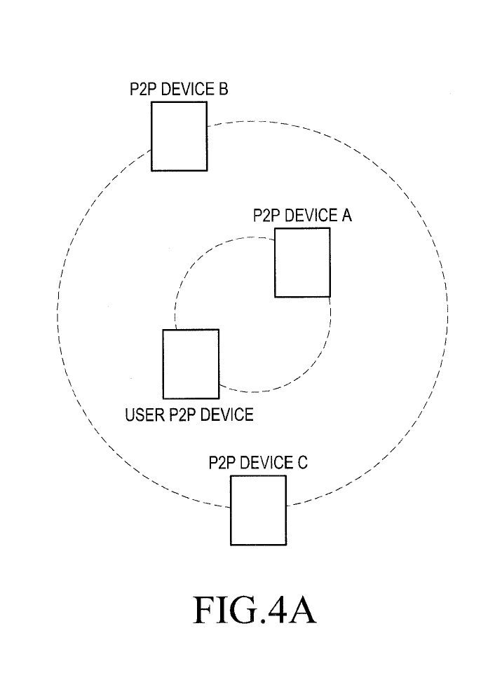

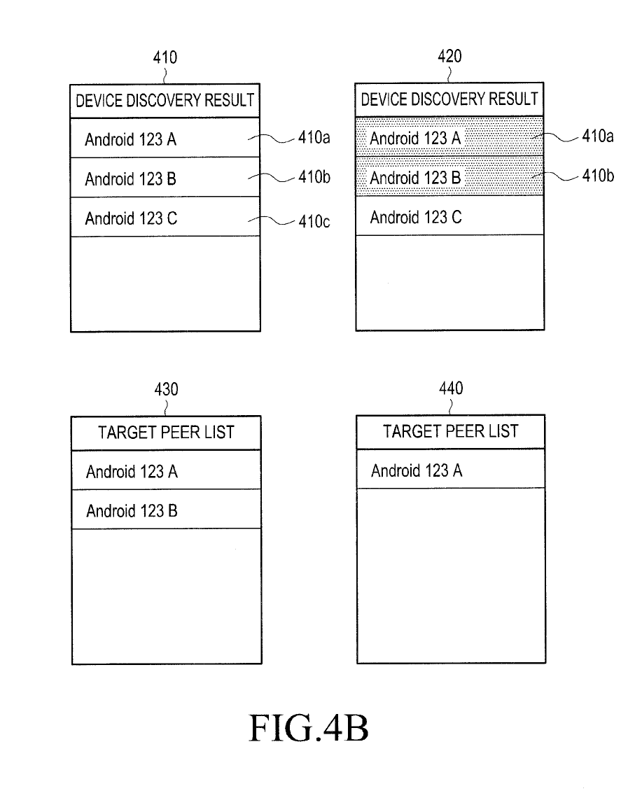

FIG. 3 is a flowchart illustrating a Wi-Fi Direct connection according to an exemplary embodiment of the present invention. FIGS. 4A and 4B are a first illustrative diagram and a second illustrative diagram of the Wi-Fi Direct connection process according to an exemplary embodiment of the present invention. The present exemplary embodiment will be described with reference to the contents described through FIG. 1, FIGS. 2A to 2D, FIG. 3, and FIGS. 4A to 4B.

In steps S301 to S302, a user P2P device performs a device discovery for a Wi-Fi Direct connection to another device, displays a discovery result, and generates a target peer list.

For example, the user P2P device searches for neighboring P2P devices via the device discovery process described above and displays a discovery result for the user in step S301.

Referring to FIG. 4A, the user P2P device attempts Wi-Fi Direct connection by identifying a P2P device A, a P2P device B, and a P2P device C in proximity with the user P2P device. In this example, the user P2P device, the P2P device A, the P2P device B, and the P2P device C comply with a Wi-Fi Direct standard.

That is, in the event that the user P2P device attempts Wi-Fi Direct connection with the P2P device A, the P2P devices discovered according to the device discovery include the P2P device A (the desired P2P device), the P2P device B, and the P2P device C.

When users of the P2P device A, the P2P device B, and the P2P device C do not separately designate their P2P device names to be used for Wi-Fi Direct, a device discovery result in the user P2P device in display 410 as illustrated in FIG. 4B.

Referring to a device discovery result 410, because the device names of the P2P device A, the P2P device B, and the P2P device C are Android 123A device 410a, Android 123B device 410b, and Android 123C device 410c, the user of the user P2P device is uncertain which is the desired P2P device that the user desires to connect to.

Accordingly, a target peer list is generated to facilitate a Wi-Fi Direct connection.

In the exemplary embodiment of the present invention, the target peer list may be generated by the user or automatically generated by the user P2P device.

In the event that the target peer list is generated by the user, when the user of the user P2P device is uncertain of the desired P2P device, the user may generate the target peer list by selecting all P2P devices estimated as the desired P2P device.

For example, as illustrated in the display 420 in FIG. 4B, the user of the user P2P device can guess the desired P2P device by selecting Android 123A device 410a and Android 123B device 410b. The target peer list is configured based on the selection of the devices and is displayed in the target peer list as illustrated in the display 430 of FIG. 4B.

After generating the target peer list, the user P2P device identifies a device type of each P2P device via in the probe response message received from discovered the P2P devices A, B and C, and classifies the P2P devices according to the device type to generate the target peer list.

For example, the user P2P device can generate a list of P2P devices corresponding to one type (or several types) of a portable terminal, a printer, a display device and the like from the discovered P2P devices as the target peer list without any selection by the user.

The generation of the target peer list with only the P2P device corresponding to a particular device type from the devices discovered according to the device discovery of Wi-Fi Direct may be changed according to a setting of the user P2P device. For example, by changing a setting, the target peer list may be generated with only the P2P device corresponding to the printer device type or a display device type.

Presuming that P2P device A (Android 123A) is a portable terminal and the target peer list is set to be generated based on P2P devices corresponding to a particular type of portable terminal, the user P2P device can generate the target peer list having only including the P2P device A (Android 123A) as illustrated in the display 440 of FIG. 4B.

Referring back to FIG. 3, the user P2P device performs the provision discovery of the PIN type with the P2P device within the generated target peer list in step S303.

For example, the user P2P device uses the PIN type of WSC. Accordingly, the user P2P device performs the provision discovery using a PIN connection type and requests performing of the provision discovery from the P2P devices within the target peer list.

In the example where the target peer list generated by the user selecting the targets, as illustrated in the display 430 of FIG. 4B, the user P2P device performs the provision discovery with the P2P device A and the P2P device B using the PIN connection type. Further, when the generated target peer list is the same as a target peer list illustrated in the display 440 of FIG. 4B, the user P2P device performs the provision discovery with the Android 123A using the PIN.

Referring back to FIG. 3, when each P2P device received the request to perform the provision discovery in the PIN form, each P2P device displays a PIN value for the user P2P device to enter in step S304. In step S305, the user P2P device inputs the PIN of the P2P device which the user P2P device desires to connect to.

The P2P device receiving the request to perform the provision discovery in the PIN connection type at step S303 randomly generates and displays a PIN value for the user P2P device to input.

For example, the user of the user P2P device can see the PIN displayed by the P2P device A, which is the desired target P2P device, and inputs the PIN after observing the generated PIN value on the display.

After input of the PIN on the user P2P device, the user P2P device generates a PIN check query request message based on the input PIN and transmits the generated PIN check query request message to the P2P devices in the target peer list, and the P2P devices receiving the PIN check query request message may transmit a PIN check query response message to the user P2P device in response to the PIN check query request message.

The user P2P device generates query data based on the preset vendor name (for example, Samsung), the service type (for example, PinValueCheck), and the PIN input by the user, and generates and transmits the PIN check query request message based on the generated query data. The P2P devices receiving the PIN check query request message may identify the vendor name, the service type, and the data included in the PIN check query request message, and responds to the PIN check query request message by generating and transmitting the corresponding PIN check query response message.

For example, the user P2P device transmits the PIN check query request message including the vendor name (Samsung®), the service type (PinValueCheck), and the data (PIN value input generated by inputting the PIN value displayed in the P2P device A by the user of the user P2P device).

The P2P device receiving the PIN check query request message has the same vendor name and service type as the PIN check query request message and determines a received PIN value. The P2P device determines a status code by comparing the generated PIN value to the received PIN value and can respond to by generating the PIN check query response message having a status code as described in the examples illustrated in FIGS. 2A to 2D.

The user P2P device determines if the status code of the PIN check query response message corresponds to a success at step 308. If the PIN check query response message does not correspond to a success, the user P2P device informs the user that the PIN does not correspond to the PIN generated by the desired P2P device. In such an example, the user may reenter the PIN value again at S305 to reattempt authorization. Referring back to S308, if the PIN check query message does correspond to success, the user P2P device performs the remaining processes for the Wi-Fi Direct connection to connect the P2P devices.

As described above, a status code is determined by identifying if the transmitted PIN value corresponds to the generated PIN value and the PIN check query response message is generated based on the set status code. Accordingly, when the user P2P device receives the PIN check query response message from the P2P devices in the target peer list, the user P2P device identifies the status code of the PIN check query response messages within the received messages.

As described above with reference to FIGS. 2A to 2D, the status code may be allocated a value for success, requested information not available, or the bad request. Accordingly, when the user P2P device identifies that the status code corresponds to requested information not available or bad request, the user P2P device informs that the PIN value input by the user of the user P2P device does not correspond to the PIN value of the P2P device for which the connection is attempted.

In contrast, when the user P2P device identifies that the status code corresponds to the success, the user P2P device performs the remaining processes (for example, group owner negotiation and provisioning) for Wi-Fi Direct connection and completes Wi-Fi Direct connection with the target P2P device.

Through the above described exemplary embodiments of the present invention, it is possible to facilitate a Wi-Fi Direct connection and prevent Wi-Fi Direct connection from failing or being delayed due to an input of a wrong PM.

While the invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A Wireless-Fidelity (Wi-Fi) Direct connection method, the method comprising:
when a Wi-Fi-Direct connection is requested, performing a device discovery to display a device discovery result and generating a target peer list from Peer-to-Peer (P2P) devices in the displayed device discovery result;
performing a provision discovery of a Personal Identification Number (PIN) connection type with the P2P devices within the target peer list;
after inputting a PIN, transmitting a PIN check query request message to the P2P devices within the target peer list, and receiving a PIN check query response message from each of the P2P devices within the target peer list; and
identifying a status code of each received PIN check query request message establishing the Wi-Fi Direct connection when the status code corresponds to a success.

2. The method of claim 1, wherein the generating of the target peer list comprises:
selecting one or more P2P devices to which the Wi-Fi Direct connection is desired to be made from the P2P devices displayed in the device discovery result; and
generating the target peer list including the selected P2P devices.

3. The method of claim 1, wherein the generating of the target peer list comprises:
identifying device types of the P2P devices displayed in the device discovery result; and
automatically generating the target peer list if any of the P2P devices displayed in the device discovery result corresponding to a preset device type.

4. The method of claim 3, further comprising, determining the device type of the P2P devices displayed in the device discovery result by evaluating a probe response message received during the device discovery.

5. The method of claim 1, wherein the provision discovery of the PIN type is performed in a PIN connection by displaying a generated PIN value on a target P2P device.

6. The method of claim 1, wherein the receiving of the PIN check query response message comprises:
when a PIN displayed on the target P2P device is input, generating the PIN check query request message based on the PIN, preset vendor name, and service type, and then transmitting the PIN check query request message to the P2P devices within the target peer list; and
receiving to the PIN check query request message at a P2P device within the target peer list and determining if a PIN value displayed on the receiving P2P device corresponds to the PIN in the PIN check query request message, determining the status code, and generating the PIN check query response message.

7. The method of claim 6, wherein the status code is set to a code corresponding to the success when a PIN displayed on the receiving P2P device corresponds to the PIN included in the received PIN check query request message.

8. The method of claim 6, wherein the status code is set to a code corresponding to bad request when the receiving P2P device does not display a PIN value.

9. The method of claim 6, wherein the status code is set to a code corresponding to requested information not available when the PIN displayed in the receiving P2P device does not correspond to the PIN included in the received PIN check query request message.

10. The method of claim 1, further comprising identifying the status code of the received PIN check query request message, and informing of a corresponding message when the status code does not correspond to the success.

11. The method of claim 1, further comprising determining a target P2P device from the P2P devices within the target peer list based on status code of the received PIN check query request message.
